(19) United States
(12) Patent Application Publication
(10) Pub. No.: US 2015/0129518 A1
(43) Pub. Date: May 14, 2015

(54) STORAGE RACK

(71) Applicant: Willy Ho, Taipei (TW)

(72) Inventor: Willy Ho, Taipei (TW)

(21) Appl. No.: 14/078,294

(22) Filed: Nov. 12, 2013

(51) Int. Cl. A47F 7/00; F16M 11/38; A47J 47/16

(52) U.S. Cl. CPC A47F 7/0064; A47J 47/16; F16M 11/38
USPC 211/41.2

(57) ABSTRACT

A storage rack assembly comprising a configurable hanging frame and one or more replaceable support elements is described. The support elements may be detachably affixed to the hanging frame. The support elements can provide a holding support at separate elevated positions along the longitudinal direction of the hanging frame. The hanging frame can have one or more frame elements detachably coupled in sequence. The frame elements can include a top frame element adapted to be mounted on an upright surface. Each frame element can have a pair of mounting arms defined with one or more pairs of receiving structures transversely for the separate elevated positions. Each support element can have an engaging structure to be removably coupled with a pair of the receiving structures of a corresponding pair of the mounting arms.

### FIELD OF INVENTION

The present invention relates generally to storages, and in particular, to a storage rack configurable to support container lids such as lids for cooking pots.

### BACKGROUND

Cooking and preparing food commonly requires the use of a variety of cooking utensils, such as containers, pots, pans, cups, glasses, etc. Some of these containers may have complementary parts, such as lids. It is typical for these parts to be moved off the vessels and separately stored. For example, when the lids are removed, they are often placed in a storage rack on the stove top, adjacent counter top, or in a fixture on a wall.

These storage racks are mostly designed specifically for a certain type of utensils, such as pot lids. When not fully utilized, these storage racks can take up available space in a kitchen environment. Further, many storage racks are installed as kitchen fixtures and can be difficult to be relocated to adapt to changes in the kitchen environment.

Thus, it is desirable to store cooking utensils in a flexible storage rack adaptable for available space in a kitchen environment.

### SUMMARY OF THE DESCRIPTION

A storage rack assembly comprises a configurable hanging frame and one or more replaceable support elements detachably affixed to the hanging frame. The support elements can provide a holding support at separate elevated positions along the longitudinal direction of the hanging frame. The hanging frame can have one or more frame elements detachably coupled in sequence. The frame elements can include a top frame element adapted to be mounted on an upright surface. Each frame element can have a pair of mounting arms defined with one or more pairs of receiving structures transversely for the separate elevated positions. Each support element can have an engaging structure to be removably coupled with a pair of the receiving structures of a corresponding pair of the mounting arms.

Other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

The present invention is illustrated by way of examples and not limitations in the figures of the accompanying drawings, in which like references indicate similar elements and in which:

FIG. 1 is a perspective view of a storage rack assembly according to some embodiments of the present invention;

FIG. 2 is an exploded view of a storage rack assembly according to one embodiment of the present invention;

FIG. 3 is a perspective view of a storage rack assembly according to an alternative embodiment of the present invention;

FIG. 4 is an exploded view of a storage rack assembly according to an alternative embodiment of the present invention;

FIG. 5 is a fragmentary view of a detachable coupling mechanism for a storage rack assembly;

FIG. 6 shows an exemplary usage of a storage rack assembly;

FIGS. 7A-7B illustrate examples of a storage rack assembly folded in a compact manner according embodiments of the present invention.

### DETAILED DESCRIPTION

In the following description, numerous specific details are set forth, such as examples of external surfaces, named components, connections between components, etc., in order to provide a thorough understanding of the present invention. It will be apparent, however, to one skilled in the art that the present invention may be practiced without these specific details. In other instances, well known components or methods have not been described in detail but rather in a block diagram in order to avoid unnecessarily obscuring the present invention. Further specific numeric references such as first, second, third, etc., may be made. However, the specific numeric references should not be interpreted as a literal sequential order but rather interpreted as references to different objects. Thus, the specific details set forth are merely exemplary. The specific details may be varied from and still be contemplated to be within the spirit and scope of the present invention.

Reference in the specification to “one embodiment” or “an embodiment” means that a particular feature, structure, or characteristic described in connection with the embodiment can be included in at least one embodiment of the invention. The appearances of the phrase “in one embodiment” in various places in the specification do not necessarily all refer to the same embodiment.

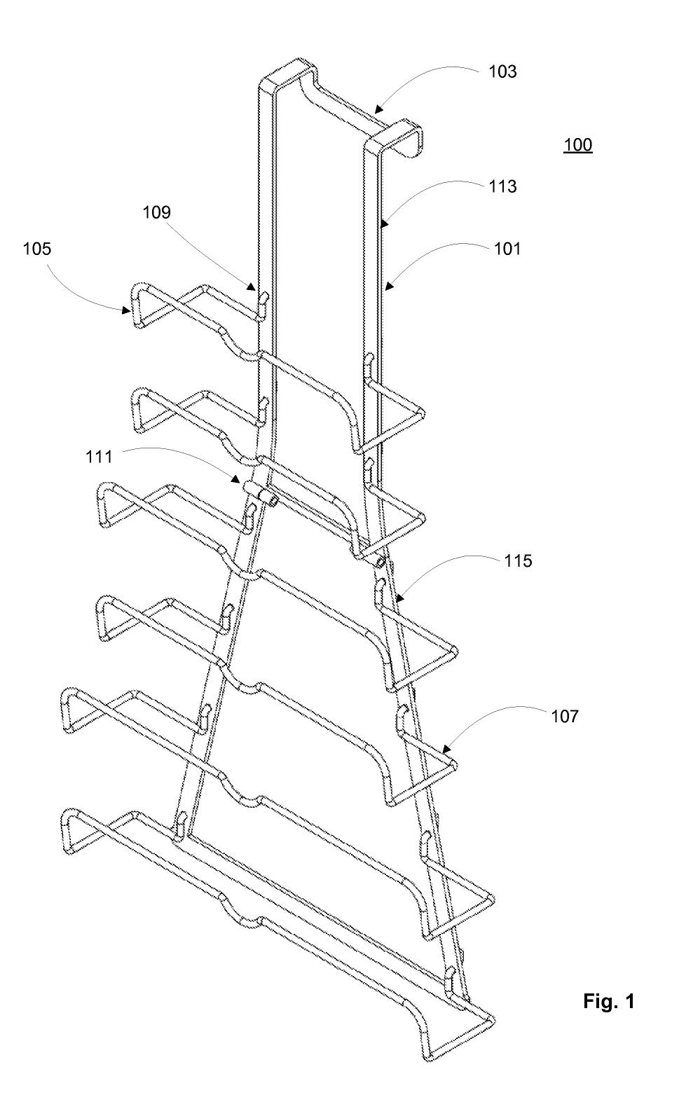

FIG. 1 is a perspective view of a storage rack assembly according to some embodiments of the present invention. Assembly 100 can include hanging frame 101 which may be expandable and/or configurable. Hanging frame 101 may include one or more frame elements 113, 115 detachably coupled in sequence, e.g. via hinge mechanism 111, along a longitudinal direction of hanging frame 101. In one embodiment, hanging frame 101 may be configured by selecting, for example, different number of frame elements and/or different sizes, shapes of frame elements coupled in sequence.

Hanging frame 101 may include top frame element 113 having an angled hook 103 adapted to be mounted on an upright surface, such as an over the door hanger over a cabinet door or other available vertical support structure. Frame elements of hanging frame 101 may be coupled to define a surface plane aligned with the upright surface. A top frame element of a hanging frame may be configured (e.g. in different shapes or with additional fastener structures) to allow alternative mounting mechanisms to secure hanging frame 101 against a surface, e.g. via removable glue material, nails, screws or other applicable holding mechanisms.

Assembly 100 may include one or more replaceable support elements 105, 107 detachably affixed to hanging frame 101, e.g. via coupling mechanism 109. Each support element may be configured to provide holding support at a separate elevated position along the longitudinal direction of hanging frame 101. A series of support elements may be attached equally or otherwise suitably spaced along hanging frame 101. The holding support for support element 105 can allow, for example, a lid placed edgeways on the support element to stand at the separate elevated position for storage. Support element 105 may be replaced with an alternative support element specifically configure for storing articles other than pot lids. For example, the alternative support element may include hooks for holding small containers or cups.

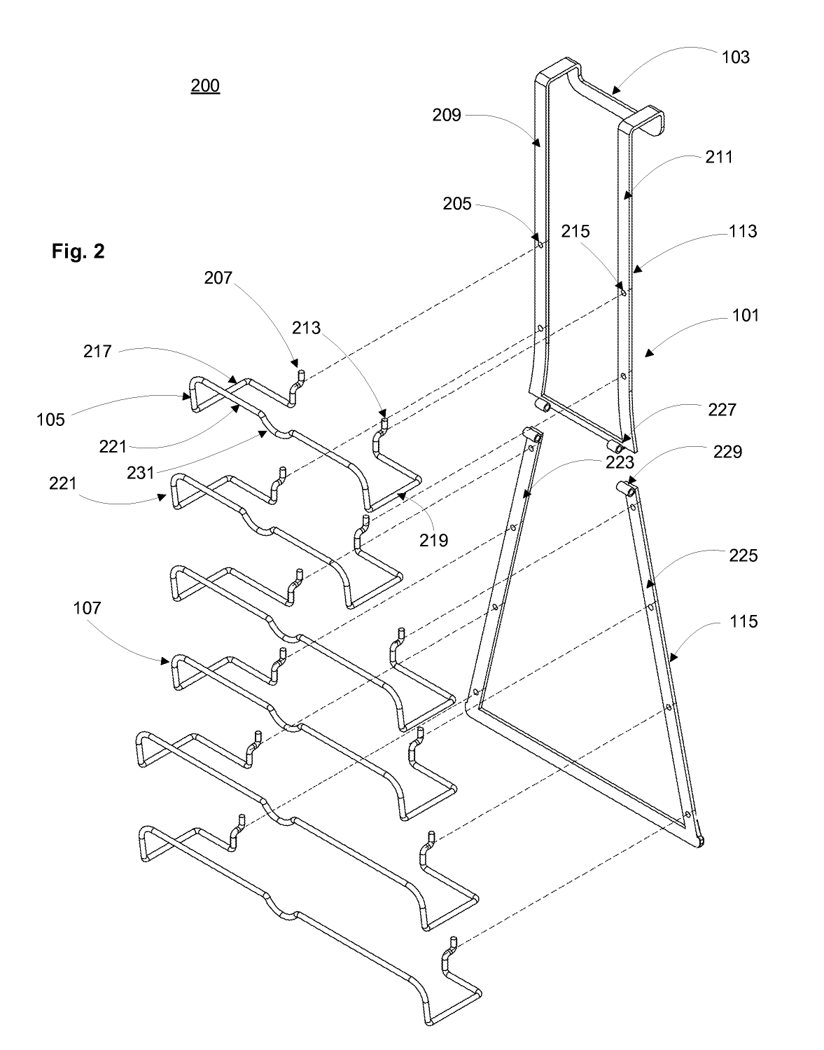

FIG. 2 is an exploded view of a storage rack assembly according to one embodiment of the present invention, such as shown in FIG. 1. Assembly 200 may include support element 105 comprising an elongated bar having a central section 221 and two side sections 217, 219. The elongated bar may be formed from a single rod bent, molded, or welded to the desired configuration, in metal, plastic, or other applicable material. The cross-section of the bar may be shaped in round, square or other applicable styles.

According to certain embodiments, side sections 217, 219 and central section 221 of support element 105 can form a loop to constrain the lid or other articles within the loop for the holding support. Central section 221 may define a back support to maintain a standing position for an article, such as a pot lid, placed edgeways against side sections 217, 219. Optionally or alternatively, central section 221 may include holding structure 231 to fittingly accommodate, for example, a handle of a lid held by support element 105. Upright surface exposed from openings between mounting arms of hanging frame 101, such as mounting arms 211, 209, may allow additional stops to position a lid placed on support element 105. Other support structures may be applicable in a support element.

In one embodiment, adjacent frame elements 113, 115 may be coupled via a hinge mechanism to allow adjacent elements 113, 115 to fold together around a hinge transversely to the longitudinal direction of hanging frame 101. Other movable, foldable mechanisms may be applicable to affix one frame element with another frame element (e.g. adjacent frame elements) to form a chain of frame elements. The length and/or capacity of a hanging frame may be adjustable by appending/removing frame elements to/from the chain.

Each frame element may be formed via a frame bar or other elongated structure. For example, the frame bar of frame element 113 can have two sections corresponding to a pair of mounting arms 211, 209 extending according to the longitudinal direction of hanging frame 101. The frame bar of frame element 113 may be flat shaped comporting a surface defined by mounting arms 211, 209. A frame element may be shaped in other applicable styles.

Hinge structure 227 may be provided or formed at or around two ends of mounting arms 209, 211 for hinge mechanism 111 to couple with corresponding hinge structure 229 at two ends of mounting arms 223,225 of adjacent frame element 115.

In one embodiment, one or more pairs of receiving structures may be defined transversely between each pair of mounting arms corresponding to separate elevated positions along hanging frame 101. Each support element can have an engaging structure to be removably coupled or mounted with a pair of the receiving structures. For example, an elongated bar of support element 105 can have two ends 207, 213, each corresponding to one engaging structure.

A pair of receiving structures of frame element 113 may comprise a pair of openings 205, 215 through a pair of mounting arms 209, 211. Engaging elements of support element 105 may be configured to include a pair of pegboard hooks 207, 213. Support element 105 may be secured to hanging frame 101 via pegboard hooks 207, 213 received via openings 205, 215.

In some embodiments, end distances between pairs of mounting arms, 209/211, 223/225, of adjacent frame elements 113,115, may be sized progressively larger or non decreasing along longitudinal direction of hanging frame 101 to allow multiple frame elements to fold together. Optionally or alternatively, lengths (e.g. vertical lengths) of adjacent frame elements may be increasingly sized to allow multiple frame elements to be folded with substantially thickness of two frame elements (e.g. two adjacent frame elements). The frame elements may be folded in a zigzag folding manner.

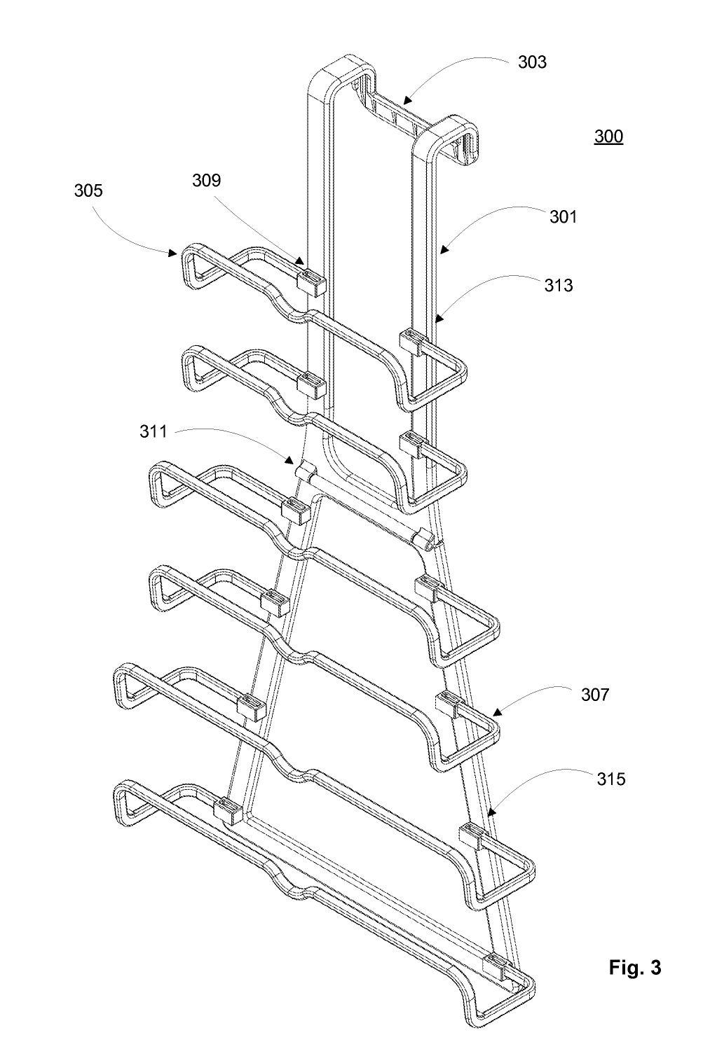

FIG. 3 is a perspective view of a storage rack assembly according to an alternative embodiment of the present invention. Assembly 300, similar to assembly 100 of FIG. 1, can include configurable hanging frame 301 with one or more frame elements 313,315 detachably coupled in sequence via hinge mechanism 311. Hanging frame 301 may include top frame element 313 having an angled hook 303. Assembly 300 may include one or more replaceable support elements 305, 307 detachably affixed to hanging frame 301 via coupling mechanism 309. Assembly 300 may be based on plastics or other applicable material suitable for use in a kitchen environment.

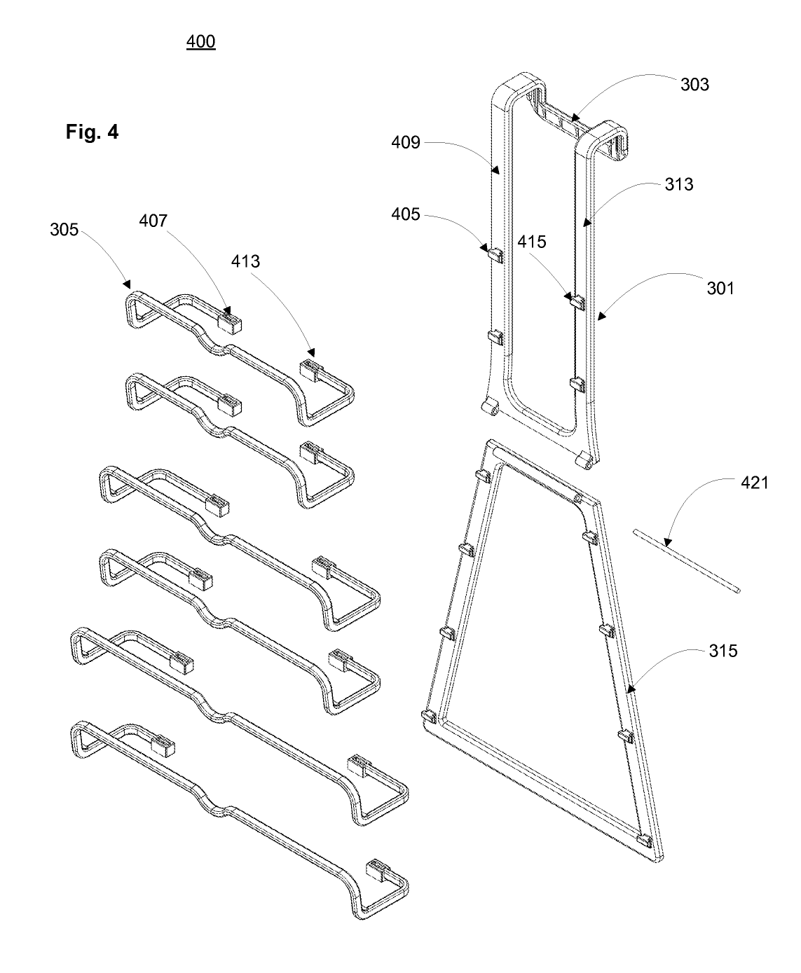

FIG. 4 is an exploded view of a storage rack assembly according to an alternative embodiment of the present invention, such as assembly 300 of FIG. 3. Assembly 400 may include support element 305 comprising an elongated square shaped bar formed as a single pipe or multiple pipe sections connected to the desired configuration. Adjacent frame elements 313, 315 may be coupled via a hinge mechanism including a removable hinge bar 421. Frame element 313 can have a pair of mounting arms defining multiple pairs of receiving structures 405, 415 to couple with engaging structures 407, 413 of support element 305 for securing support element 305 on hanging frame 301.

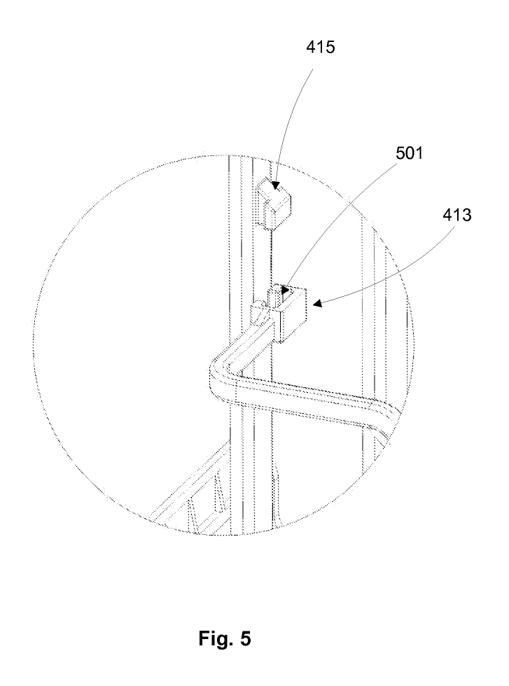

FIG. 5 is a fragmentary view of a detachable coupling mechanism for a storage rack assembly, such as assembly 400 of FIG. 4. As shown, engaging structure 413 includes housing 501 shaped to match receiving structure 415. Support element 305 can be secured to frame element 313 when receiving structure 415 is housed fittingly inside housing 501 of engaging structure 413. Support element 305 and frame element 313 can be detached by simply moving engaging structure 413 away from receiving structure 415.

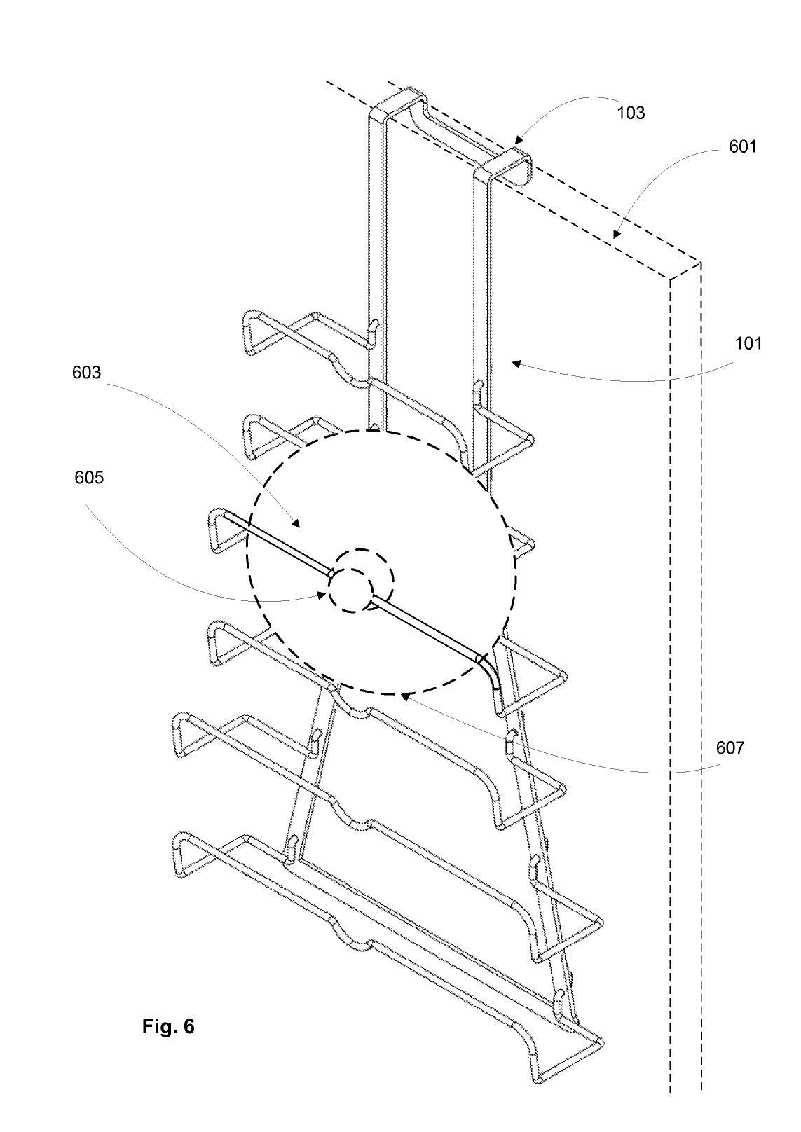

FIG. 6 shows an exemplary usage of a storage rack assembly based on, for example, assembly 100 of FIG. 1. Hanging frame 101, as shown, is mounted over a door frame 601 via an angled hook 103 to support lid 603 secured via a support element. Lid handle 605 may fittingly rest on a holding structure of the support element and a stop contact 607 on the upright surface of door frame 601 exposed via hanging frame 101.

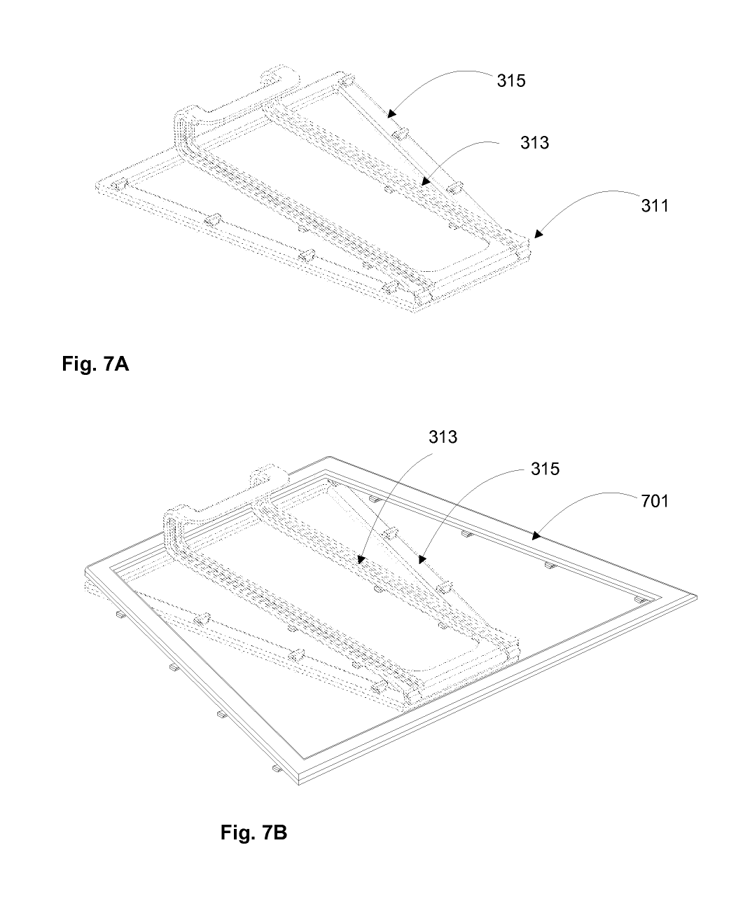

FIGS. 7A-7B illustrate examples of a storage rack assembly folded in a compact manner according embodiments of the present invention, such as assembly 300 of FIG. 3. Turning now to FIG. 7A, frame elements 313, 315 may be folded together via hinge mechanism 311. In one embodiment, the length (e.g. longitudinal length) of frame element 313 may be arranged to be shorter than the length of frame element 315 to allow frame element 315 to be extended with an additional frame element foldable together.

For example, as shown in FIG. 7B, a third frame element 701 may be hinged with frame element 315 to increase storage capacity of hanging assembly. Frame elements 701, 313 may be folded in opposite directions over frame element 315 in a zigzag manner for compact storage. Frame elements in sequence in a hanging frame may be sized (e.g. longitudinally) in a progressive manner to allow zigzag folding without adding additional width (or thickness) to the folded hanging frame. To illustrate, frame element 701 may be sized longer than frame element 315 to allow frame element 701 folded completely over frame element 315 without touching frame element 313.

Many modifications and other embodiments of the invention set forth herein will come to mind to one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A storage rack assembly comprising:
an expandable hanging frame having one or more frame elements detachably coupled in sequence along a longitudinal direction of the hanging frame, the frame elements including a top frame element having an angled hook adapted to be mounted on an upright surface, each frame element having a pair of mounting arms arranged to extend according to the longitudinal direction; and
one or more support elements detachably affixed to the hanging frame, each support element to provide a holding support at a separate elevated position along the longitudinal direction of the hanging frame, the holding support to allow a lid placed edgeways on the support element to stand at the separate elevated position for storage,
wherein one or more pairs of receiving structures are defined transversely between each pair of mounting arms of the hanging frame for the separate elevated positions, and
wherein each support element having engaging structures to removably couple with a pair of the receiving structures of a corresponding pair of the mounting arms.

2. The assembly of claim 1, wherein adjacent frame elements are coupled via a hinge mechanism to allow the adjacent elements to fold together around the hinge mechanism transversely to the longitudinal direction.

3. The assembly of claim 2, wherein the frame element comprises a frame bar having two sections corresponding to a pair of the mounting arms, wherein a hinge structure is formed around two ends of the mounting arms for the hinge mechanism.

4. The assembly of claim 3, wherein end distances between corresponding pairs of mounting arms of adjacent frame elements are sized progressively longer to allow multiple frame elements to fold together.

5. The assembly of claim 1, wherein at least one of the pairs of receiving structures comprise a pair of openings through a corresponding pair of mounting arms, and wherein the engaging elements of at least one of the support elements comprise a pair of pegboard hooks, the openings to receive the pegboard hooks to secure the one support element on the hanging frame.

6. The assembly of claim 1, wherein at least one of the support element comprises an elongated bar having a central section and two side sections forming a loop to constrain the lid within the loop for the holding support, the central section defining a back support to maintain the lid standing against the side sections edgeways.

7. The assembly of claim 6, wherein the elongated bar has two ends and wherein each end corresponds to one of the engaging structures.

8. A storage rack assembly comprising:
a configurable hanging frame having one or more frame elements detachably coupled in sequence, the frame elements including a top frame element having a mounting structure be removably mounted on an upright surface, each frame element having receiving structures defining elevated positions along the hanging frame; and
one or more support elements detachably affixed to the hanging frame, each support element to provide a holding support at separate one of the elevated positions, the holding support to allow a lid placed edgeways on the support element to stand at the separate elevated position for storage,
wherein each support element having engaging structures to removably couple with a pair of the receiving structures at a separate one of the elevated positions, and
wherein adjacent frame elements in the sequence are hinged to allow the adjacent frame elements to fold together and wherein the frame elements are sized in a progressive manner to allow multiple frame elements folded together with a thickness substantially about thickness of two adjacent frame elements.

9. The storage rack assembly of claim 8, wherein the multiple frame elements are folded in a zigzag folding manner.
